(19) United States
(12) Patent Application Publication
(10) Pub. No.: US 2005/0207309 A1
(43) Pub. Date: Sep. 22, 2005

(54) Optical data reading device and optical data writing device, and information detecting method and information detecting circuit used in the same reading and/or writing devices

(75) Inventor: Masaru Mukaida, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/082,963

(22) Filed: Mar. 18, 2005

(30) Foreign Application Priority Data
Mar. 19, 2004 (JP) 2004-081708

(51) Int. Cl. G11B 7/00

(52) U.S. Cl. 369/59.11

(57) ABSTRACT

By shaping a waveform of a level of a push-pull (PP) signal that fluctuates in accordance with a high-frequency (HF) signal that indicates written data by comparing the level to space-side slice level and a mark-side slice level as a reference value, a space-side COMPARE signal and a mark-side COMPARE signal are obtained. Further, based on a level of the HF signal, a space-side ENABLE signal and a mark-side ENABLE signal are obtained, so that if the HF signal corresponds to a space region, the space-side COMPARE signal is selected by the space-side ENABLE signal and, if the HF signal corresponds to a mark region, the mark-side COMPARE signal is selected by the mark-side ENABLE signal. In such a manner, a mistake in detecting of the mark-side COMPARE signal owing to fluctuations of the HF d signal is prevented, to obtain an accurate LPP-detected signal.

### BACKGROUND OF THE INVENTION

1. Field of the Invention

The present invention relates to an optical data reading device, an optical data writing device, and an information detecting method and circuit used in the same reading and/or writing devices and, more particularly to, an optical data reading device, an optical data writing device, and information detecting method and circuit employed in the same reading and/or writing devices being capable of being preferably applied to the case of performing a data write or read operation at a high speed to an optical storage medium such as an optical disc as in high-speed dubbing.

The present application claims priority of Japanese Patent Application No. 2004-081708 filed on Mar. 19, 2004, which is hereby incorporated by reference.

2. Description of the Related Art

An optical storage medium such as an optical disc can store a large amount of data inexpensively and also has good storage stability. Recently, its compatibility with an ROM disc (Read Only Memory disc) is highly evaluated, so that for example, a CD-R (Compact Disc-Readable) or a DVD-RW (Digital Video Disc-ReWritable) is used for writing and storing in many cases. These optical discs for writing are treated as something important because of their ability to write data patterns like the ROM disc, so that on their writing tracks, no address information or operation control information due to so-called pre-pits is formed, which is generated by the play-back signal similar to a data signal that corresponds to written data. Instead, for example, a CD-R and a CD+RW employ a method of having a meandering writing-track guide groove, to generate an operation control signal by modulating a frequency or a phase of the resultantly meandering detected signal. Further, for example, a DVD-R and a DVD-RW employ a method of having a land pre-pit (LPP) formed in a place (land) shifted from the writing track guide groove in an adjacent direction as shown in FIG. 6, to generate the operation control signal from a detected signal of the LPP. Operation control information formed by the meandering of the writing track guide groove or the LPP is read by a reading circuit and detected as a track error signal different from the data signal (light-and-shade variation signal), more specifically, as an information signal (push-pull (PP) signal) that indicates unbalance between right and left light amounts of a reflected light beam with respect to a track center axis in a far field. Thereafter, to write or read back data, a disc rotation state or address information is detected or a clock signal is extracted or an operation control signal for writing or reading (recording or playback) of that data is acquired. For example, in a DVD-R and a DVD-RW, an LPP is formed together with a wobble due to meandering of a writing track to provide operation control information, so that a wobble rotation state or the clock signal is detected from that wobble and also address information is produced, to provide the operation control signal.

Although operation control information such as a wobble or an LPP is formed in a form different from that of written data, it is impossible to prevent a level of an information signal produced by reading the operation control information from being influenced by changes in reflection coefficient of light on an optical disc that are caused by the written data. That is, the level of the information signal (PP signal) detected in a region where the data is written fluctuates due to the influence of the written data. In this case, a level of an LPP-detected signal may sometimes decrease remarkably due to a decrease in level of a high frequency (HF) signal obtained when the written data is detected, thus making it difficult to acquire address information. To solve the problem, an optical disc writing/reading device (also referred to as an optical disc recording/play-back device) has been proposed which corrects an influence due to a fluctuation in level of an HF signal on the PP signal in the region where that data is written.

Conventionally, the type of optical disc reading/writing device is made up of an optical disc 1, a spindle motor 2, a pick-up 3, a land pre-pit detecting section 4, a wobble detecting section 5, a spindle servo 6, a wobble phase locked loop (PLL) circuit 7, and an error amplifier 8 as shown in, for example, FIG. 7. The optical disc 1 is made up of, for example, a DVD-R or a DVD-RW and the spindle motor 2 rotates the optical disc 1 at a speed that is set so as to give a constant peripheral velocity. The pick-up 3 is used to read data written on the optical disc 1 and the operation control information. The land pre-pit detecting section 4 detects an LPP from the read operation control information to produce an LPP-detected signal “r” and the wobble detecting section 5 detects a wobble from that operation control information to produce a wobble-detected signal w. The spindle servo 6 controls a rotation speed of the spindle motor 2 based on the wobble-detected signal w. The wobble PLL circuit 7 stabilizes a frequency of the wobble-detected signal w to produce a stabilized wobble-detected signal aw. The error amplifier 8 amplifies an error of the LPP-detected signal “r” with respect to the stabilized wobble-detected signal aw, to output a reference clock signal ck.

FIG. 8 is a block diagram for showing an electrical configuration of the pick-up 3 and the land pre-pit detecting section 4 of FIG. 7.

As shown in FIG. 8, the pick-up 3 is made up of a divided-by-two sensor 11 and the land pre-pit detecting section 4 is made up of an adder 12, a subtracter 13, a voltage controlled amplifier (VCA) 14, a slice level setting section 15, and a comparator 16.

In the pick-up 3, a light beam reflected by the optical disc 1 during a reading operation is received by the divided-by-two sensor 11 arranged horizontally with respect to a track axis, so that received light signals a and b are output from elements 11a and 11b of the divided-by-two sensor 11 respectively. These received light signals a and b are added up by the adder 12 in the land pre-pit detecting section 4 to provide a sum, from which adder 12 an HF signal “d” is output. Simultaneously, a difference between the received light signals a and b is calculated by the subtracter 13, from which subtracter 13 a PP signal “c” is output. The PP signal “c” is amplified by the VCA14 in accordance with a level of the HF signal “d”, to output a corrected PP signal “p” in which an influence of fluctuations in level of the HF signal “d” is corrected. Further, a slice level signal “q” is set by the slice level setting section 15, so that the corrected PP signal “p” is compared to the slice level signal “q” by the comparator 16, from which comparator 16 an LPP-detected signal “r” is output.

Besides the above optical disc reading/writing device, conventionally the type of technology such as described in Japanese Patent Application Laid-open No. 2003-59054, for example, has been available.

In an optical disc reading/writing device described in Japanese Patent Application Laid-open No. 2003-59054, the PP signal is produced from the two output signals of the divided-by-two sensor in a written region, so that a read gain of the PP signal is optimized by a PP signal read gain adjusting section based on the HF signal, to correct fluctuations of the PP signal in the written region.

However, the above-described conventional optical disc reading/writing device has the following problems.

That is, the VCA14 for correcting an influence due to fluctuations in level of the HF signal “d” on the level of the PP signal “c” needs to operate at a higher speed because a higher reading or wriitng speed is recently set as in the case of, for example, a high-speed dubbing (for example, multiplied-by-16 or multiplied-by-24 speed). For example, to drive a DVD-R or a DVD+R at a multiplied-by-16 speed, the VCA14 needs to have a frequency response that is flat at least up to 100 MHz or so. However, such a VCA as to be operative in a high frequency band is difficult to realize and has a problem of large power consumption due to the high-speed operation.

Further, the optical disc reading/writing device described in Japanese Patent Application Laid-open No. 2003-59054 has the above-described problems because the PP signal read gain adjusting section has roughly the same configuration as the VCA.

### SUMMARY OF THE INVENTION

In view of the above, it is an object of the present invention to provide an optical data reading device, an optical data writing device, and information detecting method and circuit employed in the same devices.

According to a first aspect of the present invention, there is provided an optical data reading device for detecting information formed in a region near a mark and a space on an optical storage medium, the device including an information detecting section producing a first signal that changes in accordance with the mark and the space, producing a second signal that changes in accordance with the information, and comparing the second signal to a reference value and referencing the first signal to apply a value different from the reference value in accordance with the mark and the space, thereby producing a third signal that corresponds to the information.

In the foregoing, a preferable mode is one wherein the optical storage medium is made up of an optical disc in which operation control information used to control a play-back operation is formed beforehand on a writing surface in a form different from a form of the mark and the space; and
the information detecting section reads the operation control information when the optical disc is rotating to thereby produce an information signal as the second signal, compares a level of the information signal that fluctuates in accordance with the first signal that indicates the mark and the space to each reference value that corresponds to the space and the mark to thereby acquire a space-side information signal or a mark-side information signal, and selects either one of the space-side information signal and the mark-side information signal based on a level of the first signal to output an operation control signal as the third signal.

Also, a preferable mode is one wherein the information detecting section shapes a waveform of a level of the information signal that fluctuates in accordance with the first signal that indicates the mark and the space by comparing the level to each of the reference values to thereby acquire the space-side information signal and the mark-side information signal, acquires a space-side ENABLE signal and a mark-side ENABLE signal which are used to select the space-side information signal or the mark-side information signal based on the level of the first signal, and selects the space-side information signal by the space-side ENABLE signal if the first signal corresponds to the space and selects the mark-side information signal by the mark-side ENABLE signal if the first signal corresponds to the mark, to output the space-side information signal or the mark-side information signal respectively as the operation control signal.

Also, a preferable mode is one wherein the optical disc having a writing track for writing the mark and the space which track is formed radially and spirally in such a manner as to meander at a predetermined cycle, further including a divided optical sensor for receiving light reflected by the optical disc as splitting the light into two light components perpendicular to the writing track to thereby output a first received light signal and a second received light signal, the information detecting section including;
difference signal production means for obtaining a difference between the first and second received signals to produce a difference signal that corresponds to the meandering cycle;
sum signal production means for obtaining a sum of the first and second received light signals to produce a sum signal that corresponds to the mark and the space;
identification signal production means for comparing a level of the sum signal to a predetermined reference value and deciding which one of the mark and the space the sum signal corresponds to, to thereby produce an identification signal;
space-side information signal extraction means for binarizing the difference signal with respect to a first SLICE signal and, further, extracting the space-side information signal that corresponds to the space, based on the identification signal;
mark-side information signal extraction means for binarizing the difference signal with respect to a second SLICE signal and, further, extracting the mark-side information signal that corresponds to the mark, based on the identification signal; and
operation control signal output means for obtaining a sum of the space-side information signal and the mark-side information signal to thereby output the operation control signal.

Also, a preferable mode is one wherein the operation control information is made up of a land pre-pit formed in a place that is shifted from the writing track in an adjacent direction; and
the operation control signal is a land pre-pit detecting signal that is acquired by detecting the land pre-pit.

According to a second aspect of the present invention, there is provided an optical data writing device for detecting information formed in a region near a mark and a space on an optical storage medium, the device including an information detecting section producing a first signal that changes in accordance with the mark and the space, producing a second signal that changes in accordance with the information, and comparing the second signal to a reference value and referencing the first signal to apply a value different from the reference value in accordance with the mark and the space, thereby producing a third signal that corresponds to the information.

In the foregoing, a preferable mode is one wherein the optical storage medium is made up of an optical disc in which operation control information used to control a writing operation is formed beforehand on a writing surface in a form different from a form of the mark and the space; and
the information detecting section reads the operation control information when the optical disc is rotating to thereby produce an information signal as the second signal, compares a level of the information signal that fluctuates in accordance with the first signal that indicates the mark and the space to each reference value that corresponds to the space and the mark to thereby acquire a space-side information signal or a mark-side information signal, and selects either one of the space-side information signal and the mark-side information signal based on a level of the first signal to output an operation control signal as the third signal.

Also, a preferable mode is one wherein the information detecting section shapes a waveform of a level of the information signal that fluctuates in accordance with the first signal that indicates the mark and the space by comparing the level to each of the reference values to thereby acquire the space-side information signal and the mark-side information signal, acquires a space-side ENABLE signal and a mark-side ENABLE signal used to select the space-side information signal or the mark-side information signal based on the level of the first signal, and selects the space-side information signal by the space-side ENABLE signal if the first signal corresponds to the space and selects the mark-side information signal by the mark-side ENABLE signal if the first signal corresponds to the mark, to output the space-side information signal or the mark-side information signal respectively as the operation control signal.

Also, a preferable mode is one wherein the optical disc having a writing track for writing the mark and the space which track is formed radially and spirally in such a manner as to meander at a predetermined cycle, further including a divided optical sensor for receiving light reflected by the optical disc as splitting the light into two light components perpendicular to the writing track to thereby output a first received light signal and a second received light signal, the information detecting section including:
difference signal production means for obtaining a difference between the first and second received signals to produce a difference signal that corresponds to the meandering cycle;
sum signal production means for obtaining a sum of the first and second received light signals to produce a sum signal that corresponds to the mark and the space;
identification signal production means for comparing a level of the sum signal to a predetermined reference value and deciding which one of the mark and the space the sum signal corresponds to, to thereby produce an identification signal;
space-side information signal extraction means for binarizing the difference signal with respect to a first SLICE signal and, further, extracting the space-side information signal that corresponds to the space, based on the identification signal;
mark-side information signal extraction means for binarizing the difference signal with respect to a second SLICE signal and, further, extracting the mark-side information signal that corresponds to the mark, based on the identification signal; and
operation control signal output means for obtaining a sum of the space-side information signal and the mark-side information signal to thereby output the operation control signal.

Also, a preferable mode is one wherein the operation control information is made up of a land pre-pit formed in a place that is shifted from the writing track in an adjacent direction; and
the operation control signal is a land pre-pit detecting signal that is acquired by detecting the land pre-pit.

According to a third aspect of the present invention, there is provided an optical detecting method for detecting information formed in a region near a mark and a space on an optical storage medium, the method including the steps of:
producing a first signal that changes in accordance with the mark and the space;
producing a second signal that changes in accordance with the information; and
comparing the second signal to a reference value and referencing the first signal to apply a value different from the reference value in accordance with the mark and the space, thereby producing a third signal that corresponds to the information.

According to a fourth aspect of the present invention, there is provided an information detecting method used in an optical data writing device for detecting information formed in a region near a mark and a space on an optical storage medium, the method including the steps of:
producing a first signal that changes in accordance with the mark and the space;
producing a second signal that changes in accordance with the information; and
comparing the second signal to a reference value and referencing the first signal to apply a value different from the reference value in accordance with the mark and the space, thereby producing a third signal that corresponds to the information.

According to a fifth aspect of the present invention, there is provided an information detecting circuit used in the optical data reading device according to the first aspect, the circuit including:
a first circuit for producing a first signal that changes in accordance with the mark and the space;
a second circuit for producing a second signal that changes in accordance with the information; and
a third circuit for comparing the second signal to a reference value and referencing the first signal to apply a value different from the reference value in accordance with the mark and the space, thereby producing a third signal that corresponds to the information.

According to a sixth aspect of the present invention, there is provided an information detecting circuit used in the optical data writing device according to the second aspect, the circuit including:
a first circuit for producing a first signal that changes in accordance with the mark and the space;
a second circuit for producing a second signal that changes in accordance with the information; and
a third circuit for comparing the second signal to a reference value and referencing the first signal to apply a value different from the reference value in accordance with the mark and the space, thereby producing a third signal that corresponds to the information.

With the above configuration, the information detecting section is provided for producing a first signal that varies in accordance with a mark and a space on an optical storage medium and a second signal that varies in accordance with information formed in a region adjacent to the mark and the space, comparing the second signal to a reference value, and referencing the first signal to thus apply different values as the reference value in accordance with the mark and the space to produce a third signal that corresponds to the information, so that it is possible to provide an optical data reading device that can prevent a mistake in detecting of the second signal owing to fluctuations of the first signal, thereby acquiring the third signal accurately. Further, almost the same effects can be obtained by an optical data writing device.

### BRIEF DESCRIPTION OF THE DRAWINGS

The above and other objects, advantages, and features of the present invention will be more apparent from the following description taken in conjunction with the accompanying drawings, in which:

FIG. 1 is a block diagram for showing an electrical configuration of important components of an optical data reading device according to a first embodiment of the present invention;

FIG. 2 is a block diagram for showing an electrical configuration of a pick-up and a land pre-pit detecting section of FIG. 1;

FIG. 3 is a timing chart of signals of various components for explanation of operations of the land pre-pit detecting section of FIG. 2;

FIG. 4 is a block diagram for showing an electrical configuration of important components of an optical data writing device according to a second embodiment of the present invention;

FIG. 5 is a timing chart of signals of various components for explanation of operations of the land pre-pit detecting section of FIG. 2;

FIG. 6 is an illustration for showing a structure of an optical disc;

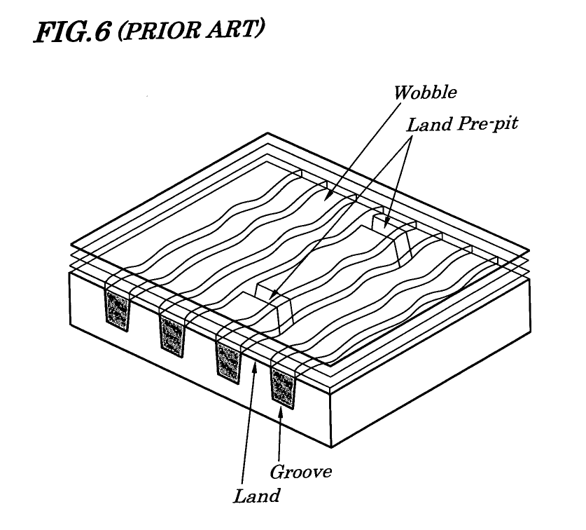

FIG. 7 is a block diagram for showing an electrical configuration of important components of a conventional optical data reading/writing device; and

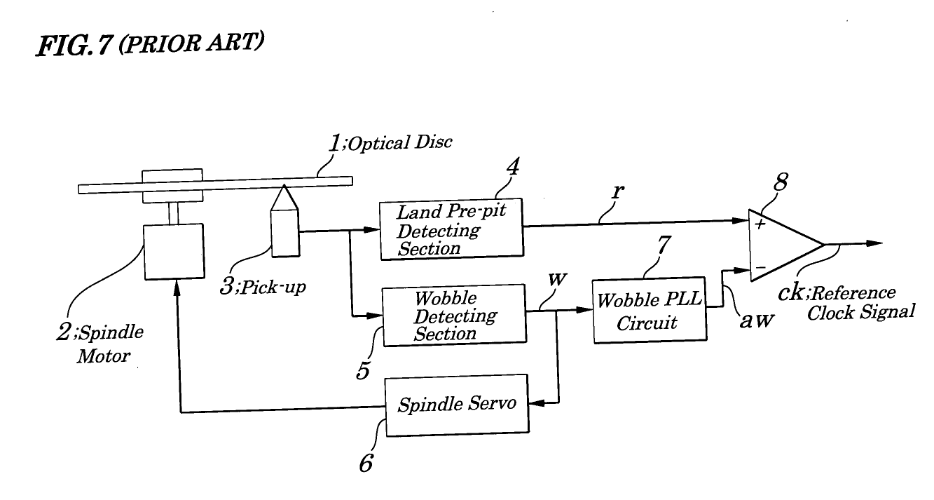

FIG. 8 is a block diagram for showing an electrical configuration of a pick-up and a land pre-pit detecting section of FIG. 7.

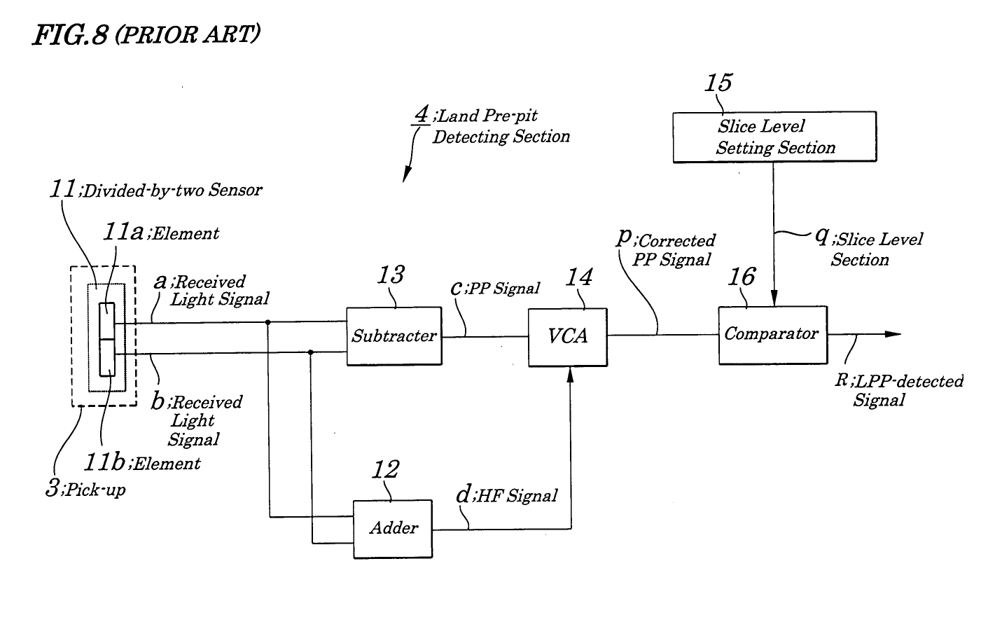

### DETAILED DESCRIPTION OF THE PREFERRED EMBODIMENTS

Best mode of carrying out the present invention will be described in further detail using various embodiments with reference to the accompanying drawings.

An optical data reading device (also known as a play-back device) and an optical data writing device (also referred to as a recording device) are provided for producing an information signal by reading a wobble or an LPP when an optical disc is rotating, comparing a level of the information signal that varies with a data signal that indicates written data to each reference value that corresponds to a space or a mark to thereby acquire a space-side information signal or a mark-side information signal respectively, selecting either one of these space-side information signal and mark-side information signal based on a level of the data signal to thereby produce an operation control signal, and reading (playing back) written data based on the operation control signal, and writing data to be written, based on the operation control signal respectively.

### First Embodiment

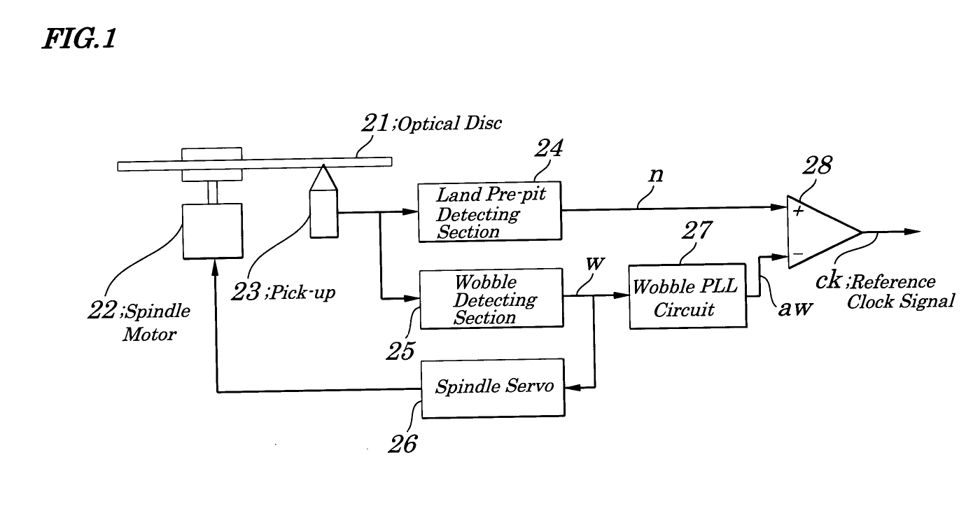

FIG. 1 is a block diagram for showing an electrical configuration of important components of an optical data reading device according to the first embodiment of the present invention.

As shown in the same figure, the optical data reading device of the present embodiment is an optical disc reading device and made up of an optical disc 21, a spindle motor 22, a pick-up 23, a land pre-pit detecting section 24, a wobble detecting section 25, a spindle servo 26, a wobble PLL circuit 27, and an error amplifier 28.

The optical disc 21 is made up of, for example, a DVD-R or a DVD-RW and has writing tracks for writing data (forming mark and space). The recoding track is formed radially and spirally in such a manner as to meander at a predetermined cycle. Besides, on the optical disc 21, an LPP for controlling a reading operation is formed in a region near the mark and space. These meandering writing track and LPP make up operation control information that is formed beforehand on a writing surface in a different form from that of the mark and space. The spindle motor 22 rotates the optical disc 21 at a speed that is set so as to give a constant peripheral velocity. The pick-up 23 is arranged to read the written data and the operation control information on the optical disc 21.

The land pre-pit detecting section 24 detects an LPP from the read operation control information, to acquire a control signal (LPP-detected signal “n”). Especially, in the present embodiment, the land pre-pit detecting section 24 reads the operation control information when the optical disc 21 is rotating, to produce an information signal (second signal) and compare a level of the information signal that fluctuates in accordance with a data signal (first signal) indicative of written data to each reference value that corresponds to a space and a mark, thereby acquiring a space-side information signal or a mark-side information signal so that either one of these space-side information signal and the mark-side information signal may be selected on the basis of a level of the data signal and output as the LPP-detected signal “n” (third signal).

The wobble detecting section 25 detects a wobble from the operation control signal, to produce a wobble-detected signal w. The spindle servo 26 controls a rotation speed of the spindle motor 22 based on the wobble-detected signal w. The wobble PLL circuit 27 stabilizes a frequency of the wobble-detected signal w, to produce a stabilized wobble-detected signal aw. The error amplifier 28 amplifies an error of the LPP-detected signal “n” with respect to the stabilized wobble-detected signal aw, to output a reference clock signal ck.

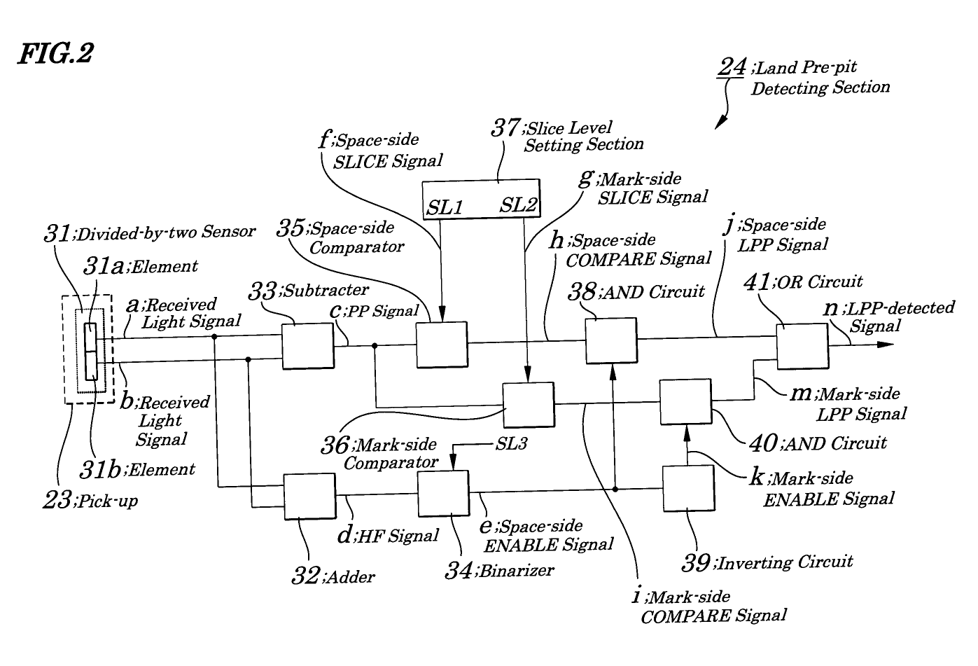

FIG. 2 is a block diagram for showing an electrical configuration of the pick-up 23 and the land pre-pit detecting section 24 of FIG. 1.

As shown in FIG. 2, the pick-up 23 is made up of a divided-by-two sensor 31 and the land pre-pit detecting section 24 is made up of an adder 32, a subtracter 33, a binarizer 34, space-side comparator 35, a mark-side comparator 36, a slice level setting section 37, an AND circuit 38, an inverting circuit 39, an AND circuit 40, and an OR circuit 41. The divided-by-two sensor 31 receives light reflected by the optical disc 21 as splitting it perpendicular to the writing tracks, to output received-light signals a and b from elements 31a and 31b respectively. The adder 32 adds up the received-light signals a and b, to produce a sum signal (HF signal “d”) that corresponds to the written data. The subtracter 33 acquires a difference between the received-light signals a and b, to produce a difference signal (PP signal c) that corresponds to a meandering cycle of the writing track of the optical disc 21.

The binarizer 34 compares a level of the HF signal “d” to a predetermined reference value SL3, to decide which one of the mark and the space the HF signal “d” corresponds to, thereby producing an identification signal (space-side ENABLE signal e). The slice level setting section 37 is made up of, for example, a reference voltage source, to output a space-side SLICE signal “f” that is set to a reference value SL1 that corresponds to the space and a mark-side SLICE signal “g” that is set to a reference value SL2 that corresponds to the mark. The space-side comparator 35 shapes (binarizes) a waveform of the PP signal “c” with respect to the first SLICE signal (space-side SLICE signal f), to output a space-side COMPARE signal h. The AND circuit 38 takes a logical product of the space-side COMPARE signal “h” and the space-side ENABLE signal e, to extract a space-side information signal (space-side LPP signal j) that corresponds to the space.

The mark-side comparator 36 shapes (binarizes) a waveform of the PP signal “c” with respect to the second SLICE signal (mark-side SLICE signal g), to output a mark-side COMPARE signal i. The inverting circuit 39 inverts the space-side ENABLE signal “e” to output a mark-side ENABLE signal “k”. The AND circuit 40 takes a logical product of the mark-side COMPARE signal “i” and the mark-side ENABLE signal “k”, to extract a mark-side information signal (mark-side LPP signal m) that corresponds to the mark side. The OR circuit 41 takes a logical sum of the space-side LPP signal “j” and the mark-side LPP signal m, to output the LPP-detected signal “n”. It is to be noted that the land pre-pit detecting section 24 is incorporated in a one-chip large scale integration (LSI).

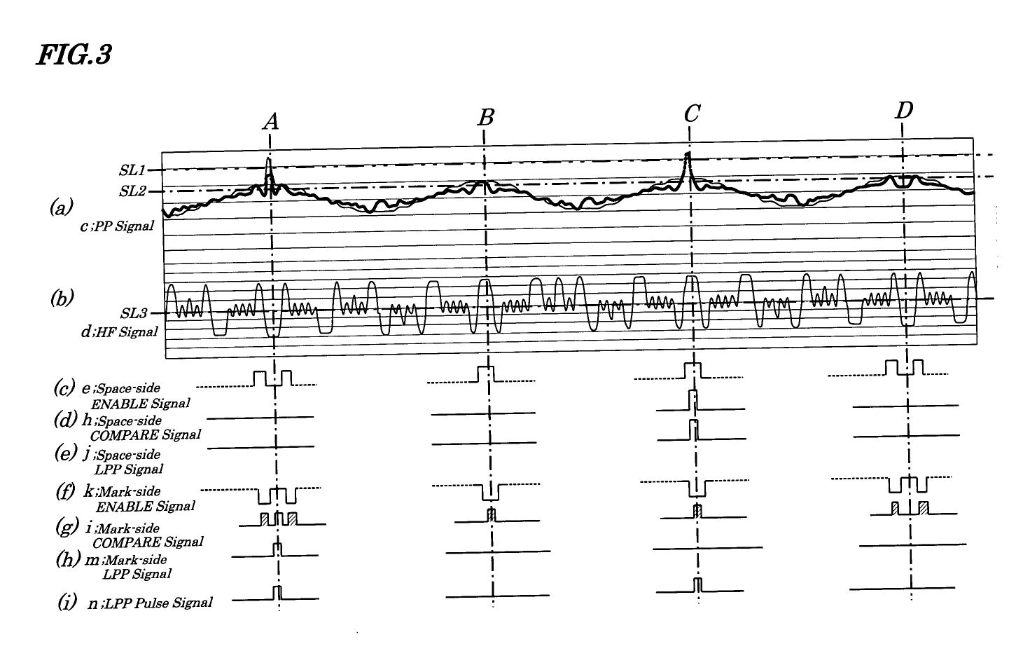

FIG. 3 is a timing chart of signals of various components for explanation of operations of the land pre-pit detecting section 24 shown in FIG. 2, in which a vertical axis represents a voltage level or a logical level and a horizontal axis represents time.

The following will describe an information detecting method employed in the optical disc reading device of the present embodiment, with reference to FIG. 3.

It is to be noted that in FIG. 3, land pre-pits are to be detected at points in time A and C and not at points in time B and D. In the optical disc reading device, the operation control signal (LPP-detected signal “n”) that indicates operation control information (LPP) is detected when the optical disc 21 is rotating.

That is, a light beam reflected by the optical disc 21 during play-back is received by the divided-by-two sensor 31 arranged horizontally with respect to an axis of the writing tracks, so that the received light signals a and b are output from the elements 31a and 31b of the divided-by-two sensor 31 respectively. These received light signals a and b are added up by the adder 32 to provide a sum, from which adder 32 the HF signal “d” is output. Simultaneously, a difference between the received light signals a and b is calculated by the subtracter 33, from which subtracter 33 the PP signal “c” is output.

The HF signal “d” is input to the binarizer 34 and the PP signal “c” is input to the space-side comparator 35 and the mark-side comparator 36. In this case, as shown in (a) of FIG. 3, the PP signal “c” (thick line) has fluctuations due to an influence of the HF signal “d” shown in (b) of FIG. 3 more than the PP signal “c” (thin line) in an unwritten range. For example, at point in time C, the HF signal “d” corresponds to a space region and suffers no drop in amount of light reflected from the writing surface of the optical disc 21, so that the PP signal “c” does not change in level. However, at point in time A, the HF signal “d” corresponds to a mark region and suffers a drop in amount of the reflected light, so that the level of the PP signal “c” is decreased.

Further, the slice level setting section 37 sets the space-side SLICE signal “f” to the space-side comparator 35 and the mark-side SLICE signal “g” to the mark-side comparator 36. A slice level of the space-side SLICE signal “f” is a reference value SL1 and that of the mark-side SLICE signal “g” is a reference value SL2 shown in (a) of FIG. 3. The HF signal “d” is binarized by the binarizer 34 with reference to the slice level SL3 shown in (b) of FIG. 3, from which binarizer 34 the space-side ENABLE signal “e” as shown in (c) of FIG. 3 is output. It is to be noted that if the HD signal “d” corresponds to the space region, the space-side ENABLE signal “e” is at a high level. Furthermore, the space-side ENABLE signal “e” is inverted in logical level by the inverting circuit 39, from which inverting circuit 39 the mark-side ENABLE signal “k” shown in (f) of FIG. 3 is output.

Further, the PP signal “c” is compared by the space-side comparator 35 to the reference slice level SL1 of the space-side SLICE signal f, from which space-side comparator 35 the space-side COMPARE signal “h” shown in (d) of FIG. 3 is output. The space-side COMPARE signal “h” and the space-side ENABLE signal “e” are input to the AND circuit 38 to be AND-tied, from the AND circuit 38 the space-side LPP signal “j” shown in (e) of FIG. 3 is output.

Further, the PP signal “c” is compared by the mark-side comparator 36 to the reference slice level SL2 of the mark-side SLICE signal g, from which mark-side comparator 36 the mark-side COMPARE signal “i” shown in (g) of FIG. 3 is output. The mark-side COMPARE signal “i” and the mark-side ENABLE signal “k” are input to the AND circuit 40 to be AND-tied, from the AND circuit 40 the mark-side LPP signal “m” shown in (h) of FIG. 3 is output. From the mark-side LPP signal “m”, an erroneous LPP pulse (see a hatched portion in (g) of FIG. 3) that occurs in the mark-side COMPARE signal “i” shown in (g) of FIG. 3 has been removed. The space-side LPP signal “j” and the mark-side LPP signal “m” are input to the OR circuit 41 to be OR-tied, from the OR circuit 41 the LPP-detected signal “n” shown in (i) of FIG. 3 is output. Based on the LPP-detected signal “n”, the written data is read.

As described above, in the first embodiment, by comparing the level of the PP signal “c” that fluctuates in accordance with the HF signal “d” indicative of the written data to the reference slice levels SL1 and SL2 of the space side and the mark side respectively so that its waveform may be shaped, the space-side COMPARE signal “h” and the mark-side COMPARE signal “i” are obtained, based on which HF signal “d”, the space-side ENABLE signal “e” and the mark-side ENABLE signal “k” are obtained so that if the HF signal “d” corresponds to the space region the space-side COMPARE signal “h” may be selected by the space-side ENABLE signal “e” and, if the HF signal “d” corresponds to the mark region the mark-side COMPARE signal “i” may be selected by the mark-side ENABLE signal “k”. Therefore, a mistake in detecting of the mark-side COMPARE signal “i” owing to fluctuations of the HF signal “d” is avoided, thereby enabling acquiring the accurate LPP-detected signal “n”. Further, the land pre-pit detecting section 24, which is made up of a comparator and a logical circuit, operates at a high speed on low power consumption.

### Second Embodiment

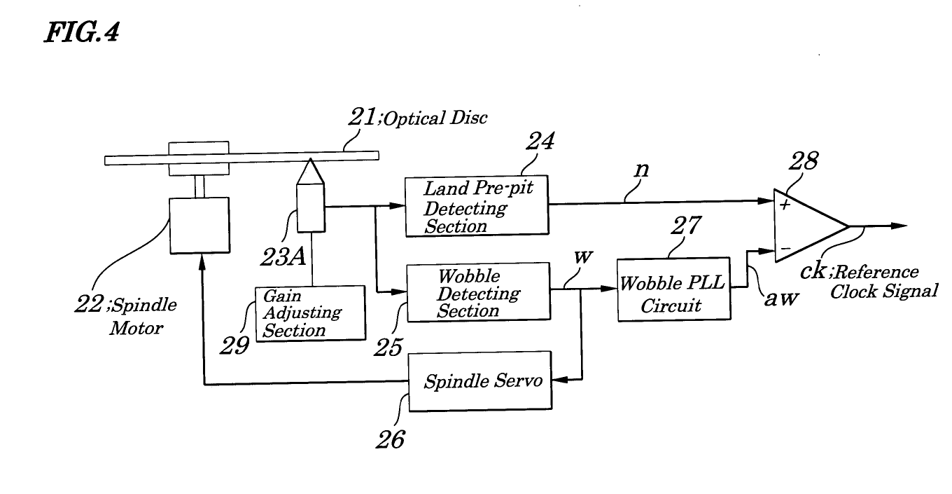

FIG. 4 is a block diagram for showing an electrical configuration of important components of an optical data writing device according to the second embodiment of the present invention, in which the components that correspond to those of FIG. 1 showing the first embodiments are indicated by the same symbols.

As shown in FIG. 4, the optical data writing device of the present embodiment is an optical disc writing device in which the pick-up 23 of FIG. 1 is replaced by a pick-up 23A having a different configuration and a gain adjusting section 29 is provided. The pick-up 23A has the functions of the pick-up 23 and has such a configuration that its photoelectric transfer gain may be adjusted by the gain adjusting section 29. The gain adjusting section 29 adjusts the photoelectric transfer gain of the pick-up 23A in such a manner as to keep light amounts and linearity of received light signals a and b of FIG. 2 and light reflected by an optical disc 21 when data is being written. The others are the same as FIG. 1.

According to a method employed in the optical disc writing device of the present embodiment, to form a mark and a space that correspond to data when the data is being written, intensity of a laser beam with which a writing surface of the optical disc 21 is irradiated is varied, so that an amount of light reflected by the writing surface also varies. Therefore, to obtain the received light signals a and b that have linearity against the light amount of the light reflected by the optical disc 21, the photoelectrical transfer gain of the pick-up 23A is adjusted by the gain adjusting section 29.

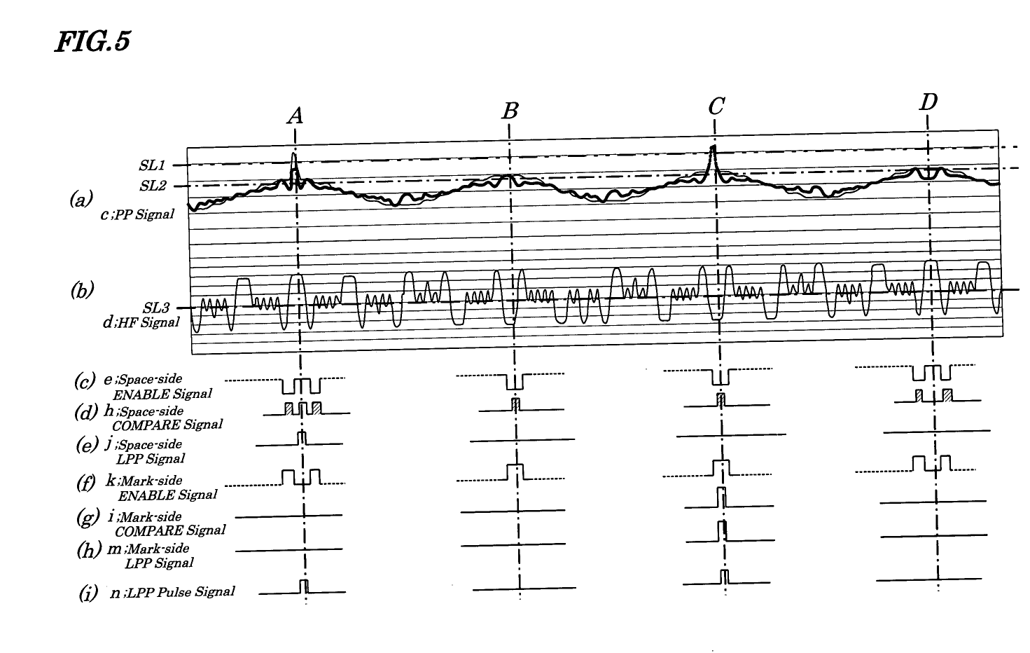

Further, the intensity of the laser beam emitted to form the mark is larger than that of the laser beam emitted to form the space, so that the amount of the reflected light beam during the formation of the mark is larger than that of the reflected light beam during the formation of the space. Therefore, a level of an HD signal “d” that is output from the adder 32 during an writing operation is higher when the mark is being formed than when the space is being formed, so that as shown in (a) of FIG. 5 its waveform changes in a phase opposite to that of the play-back waveform shown in (b) of FIG. 3.

It is to be noted that in FIG. 2 the space-side ENABLE signal “e” output from the binarizer 34 becomes valid when a mark is formed and the mark-side ENABLE signal “k” output from the inverting circuit 39 becomes valid when a space is formed. Therefore, a space-side ENABLE signal “e” shown in (c) of FIG. 5 has the same waveform as the mark-side ENABLE signal “k” shown (f) of FIG. 3, a space-side COMPARE signal “h” shown in (d) of FIG. 5 has the same waveform as the mark-side COMPARE signal “i” shown in (g) of FIG. 3, and a space-side LPP signal “j” shown in (e) of FIG. 5 has the same waveform as the mark-side LPP signal “m” shown in (h) of FIG. 3. Further, a mark-side ENABLE signal “k” shown in (f) of FIG. 5 has the same waveform as the space-side ENABLE signal “e” of (c) of FIG. 3, a mark-side COMPARE signal “i” shown in (g) of FIG. 5 has the same waveform as the space-side COMPARE signal “h” of (d) of FIG. 3, and a mark-side LPP signal “m” shown in (h) of FIG. 5 has the same waveform as the space-side LPP signal “j” shown in (e) of FIG. 3. With this, similar to the first embodiment, an operation control signal (LPP-detected signal “n”) is detected which indicates operation control information (LPP) when the optical disc 21 is rotating. Based on the LPP-detected signal “n”, data is written.

As described above, the second embodiment has the same merits also on the optical disc device as the first embodiment.

Although the embodiments of the present invention have been described in detail with reference to the drawings, the specific configuration is not limited to them and any alterations in design are covered by the present invention as far as they do not depart from the gist of the present invention.

For example, any configuration other than those of the optical disc reading device shown in FIG. 1 and the optical disc writing device shown in FIG. 4 may be employed as far as it can accommodate the land pre-pit detecting section 24. Further, although the land pre-pit detecting section 24 of FIG. 2 has been provided with two comparators of the space-side comparator 35 and the mark-side comparator 36, one comparator may be used in configuration so that a reference value may change dynamically for the space and the mark. However, in this case, it is assumed that transition from the space to the mark and vice versa may have no time delay in changing of the reference value.

The optical data reading device and the optical data writing device of the present invention could well be applied to reading and writing (play-back and recording) of general optical storage media in which operation control information used to control writing and reading operations is formed beforehand on a writing surface in a form different from that for a mark and a space.

1. An optical data reading device for detecting information formed in a region near a mark and a space on an optical storage medium, said device comprising:
an information detecting section producing a first signal that changes in accordance with the mark and the space, producing a second signal that changes in accordance with the information, and comparing the second signal to a reference value and referencing the first signal to apply a value different from the reference value in accordance with the mark and the space, thereby producing a third signal that corresponds to the information.

2. The optical data reading device according to claim 1, wherein:
the optical storage medium comprises an optical disc in which operation control information used to control a play-back operation is formed beforehand on a writing surface in a form different from a form of the mark and the space; and
said information detecting section reads the operation control information when the optical disc is rotating to thereby produce an information signal as the second signal, compares a level of the information signal that fluctuates in accordance with the first signal that indicates the mark and the space to each reference value that corresponds to the space and the mark to thereby acquire a space-side information signal or a mark-side information signal, and selects either one of the space-side information signal and the mark-side information signal based on a level of the first signal to output an operation control signal as the third signal.

3. The optical data reading device according to claim 2, wherein said information detecting section shapes a waveform of a level of the information signal that fluctuates in accordance with the first signal that indicates the mark and the space by comparing the level to each of the reference values to thereby acquire the space-side information signal and the mark-side information signal, acquires a space-side ENABLE signal and a mark-side ENABLE signal which are used to select the space-side information signal or the mark-side information signal based on the level of the first signal, and selects the space-side information signal by the space-side ENABLE signal if the first signal corresponds to the space and selects the mark-side information signal by the mark-side ENABLE signal if the first signal corresponds to the mark, to output the space-side information signal or the mark-side information signal respectively as the operation control signal.

4. The optical data reading device according to claim 2, wherein the optical disc having a writing track for writing the mark and the space which track is formed radially and spirally in such a manner as to meander at a predetermined cycle, further comprising a divided optical sensor for receiving light reflected by the optical disc as splitting the light into two light components perpendicular to the writing track to thereby output a first received light signal and a second received light signal, said information detecting section comprising;
difference signal production means for obtaining a difference between the first and second received signals to produce a difference signal that corresponds to the meandering cycle;
sum signal production means for obtaining a sum of the first and second received light signals to produce a sum signal that corresponds to the mark and the space;
identification signal production means for comparing a level of the sum signal to a predetermined reference value and deciding which one of the mark and the space the sum signal corresponds to, to thereby produce an identification signal;
space-side information signal extraction means for binarizing the difference signal with respect to a first SLICE signal and, further, extracting the space-side information signal that corresponds to the space, based on the identification signal;
mark-side information signal extraction means for binarizing the difference signal with respect to a second SLICE signal and, further, extracting the mark-side information signal that corresponds to the mark, based on the identification signal; and
operation control signal output means for obtaining a sum of the space-side information signal and the mark-side information signal to thereby output the operation control signal.

5. The optical data reading device according to claim 4, wherein:
the operation control information is composed of a land pre-pit formed in a place that is shifted from the writing track in an adjacent direction; and
the operation control signal is a land pre-pit detecting signal that is acquired by detecting the land pre-pit.

6. An optical data writing device for detecting information formed in a region near a mark and a space on an optical storage medium, said device comprising:
an information detecting section producing a first signal that changes in accordance with the mark and the space, producing a second signal that changes in accordance with the information, and comparing the second signal to a reference value and referencing the first signal to apply a value different from the reference value in accordance with the mark and the space, thereby producing a third signal that corresponds to the information.

7. The optical data writing device according to claim 6, wherein:
the optical storage medium comprises an optical disc in which operation control information used to control a writing operation is formed beforehand on a writing surface in a form different from a form of the mark and the space; and
said information detecting section reads the operation control information when the optical disc is rotating to thereby produce an information signal as the second signal, compares a level of the information signal that fluctuates in accordance with the first signal that indicates the mark and the space to each reference value that corresponds to the space and the mark to thereby acquire a space-side information signal or a mark-side information signal, and selects either one of the space-side information signal and the mark-side information signal based on a level of the first signal to output an operation control signal as the third signal.

8. The optical data writing device according to claim 7, wherein said information detecting section shapes a waveform of a level of the information signal that fluctuates in accordance with the first signal that indicates the mark and the space by comparing the level to each of the reference values to thereby acquire the space-side information signal and the mark-side information signal, acquires a space-side ENABLE signal and a mark-side ENABLE signal used to select the space-side information signal or the mark-side information signal based on the level of the first signal, and selects the space-side information signal by the space-side ENABLE signal if the first signal corresponds to the space and selects the mark-side information signal by the mark-side ENABLE signal if the first signal corresponds to the mark, to output the space-side information signal or the mark-side information signal respectively as the operation control signal.

9. The optical data writing device according to claim 7, wherein the optical disc having a writing track for writing the mark and the space which track is formed radially and spirally in such a manner as to meander at a predetermined cycle, further comprising a divided optical sensor for receiving light reflected by the optical disc as splitting the light into two light components perpendicular to the writing track to thereby output a first received light signal and a second received light signal, said information detecting section comprising:
difference signal production means for obtaining a difference between the first and second received signals to produce a difference signal that corresponds to the meandering cycle;
sum signal production means for obtaining a sum of the first and second received light signals to produce a sum signal that corresponds to the mark and the space;
identification signal production means for comparing a level of the sum signal to a predetermined reference value and deciding which one of the mark and the space the sum signal corresponds to, to thereby produce an identification signal;
space-side information signal extraction means for binarizing the difference signal with respect to a first SLICE signal and, further, extracting the space-side information signal that corresponds to the space, based on the identification signal;
mark-side information signal extraction means for binarizing the difference signal with respect to a second SLICE signal and, further, extracting the mark-side information signal that corresponds to the mark, based on the identification signal; and
operation control signal output means for obtaining a sum of the space-side information signal and the mark-side information signal to thereby output the operation control signal.

10. The optical data writing device according to claim 9, wherein:
the operation control information is composed of a land pre-pit formed in a place that is shifted from the writing track in an adjacent direction; and
the operation control signal is a land pre-pit detecting signal that is acquired by detecting the land pre-pit.

11. An information detecting method used in an optical data reading device for detecting information formed in a region near a mark and a space on an optical storage medium, said method comprising the steps of:
producing a first signal that changes in accordance with the mark and the space;
producing a second signal that changes in accordance with the information; and
comparing the second signal to a reference value and referencing the first signal to apply a value different from the reference value in accordance with the mark and the space, thereby producing a third signal that corresponds to the information.

12. An information detecting method used in an optical data writing device for detecting information formed in a region near a mark and a space on an optical storage medium, the method comprising the steps of:
producing a first signal that changes in accordance with the mark and the space;
producing a second signal that changes in accordance with the information; and
comparing the second signal to a reference value and referencing the first signal to apply a value different from the reference value in accordance with the mark and the space, thereby producing a third signal that corresponds to the information.

13. An information detecting circuit used in the optical data reading device according to claim 1, the circuit comprising:
a first circuit for producing the first signal that changes in accordance with the mark and the space;
a second circuit for producing the second signal that changes in accordance with the information; and
a third circuit for comparing the second signal to the reference value and referencing the first signal to apply the value different from the reference value in accordance with the mark and the space, thereby producing the third signal that corresponds to the information.

14. An information detecting circuit used in the optical data writing device according to claim 6, the circuit comprising:
a first circuit for producing the first signal that changes in accordance with the mark and the space;
a second circuit for producing the second signal that changes in accordance with the information; and
a third circuit for comparing the second signal to the reference value and referencing the first signal to apply the value different from the reference value in accordance with the mark and the space, thereby producing the third signal that corresponds to the information.

15. An optical data reading device for detecting information formed in a region near a mark and a space on an optical storage medium, said device comprising:
an information detecting means for producing a first signal that changes in accordance with the mark and the space, producing a second signal that changes in accordance with the information, and comparing the second signal to a reference value and referencing the first signal to apply a value different from the reference value in accordance with the mark and the space, thereby producing a third signal that corresponds to the information.

16. An optical data writing device for detecting information formed in a region near a mark and a space on an optical storage medium, said device comprising:
an information detecting means for producing a first signal that changes in accordance with the mark and the space, producing a second signal that changes in accordance with the information, and comparing the second signal to a reference value and referencing the first signal to apply a value different from the reference value in accordance with the mark and the space, thereby producing a third signal that corresponds to the information.
